(19) United States
(12) Patent Application Publication
(10) Pub. No.: US 2013/0315651 A1
(43) Pub. Date: Nov. 28, 2013

(54) FILE NOTE DEVICE

(71) Applicant: STEVEN MARK LEVINSOHN, JOHANNESBURG (ZA)

(72) Inventor: STEVEN MARK LEVINSOHN, JOHANNESBURG (ZA)

(21) Appl. No.: 13/950,433

(22) Filed: Jul. 25, 2013

(30) Foreign Application Priority Data
Jul. 25, 2012 (ZA) 2012/0565

(51) Int. Cl. B42F 3/00; B42F 13/00

(52) U.S. Cl. CPC B42F 3/003; B42F 13/0093
USPC 402/4; 402/79

(57) ABSTRACT

This invention relates generally to a file note device for use with a file or stack of sheets bound together by way of one or more binding members disposed through substantially aligned apertures in the sheets, the file note device comprising a planar body including a note zone; and an engagement zone located adjacent an edge portion of the planar body. The engagement zone comprises at least one pair of spaced apart teeth defining a binding member recess therebetween, wherein at least one tooth defines a retaining formation for removably retaining the binding member in the binding member recess, in use. It will be noted that the invention also relates to a bound file comprising one or more file note file note devices in accordance with the invention and a method of providing a note on a file or stack of bound sheets.

### BACKGROUND OF THE INVENTION

THIS INVENTION relates to a file note device, to a bound file comprising one or more file note devices, and to a method of providing a not on a file or stack of bound sheets.

Planar sheets of writing material, such as paper, are often stacked and bound together to form a bound file or pad. It will be appreciated that binding of sheets may be achieved in a plurality of different ways including comb or wire binding.

For binding in the abovementioned fashion, a plurality of apertures is made at a predetermined zone on all sheets to be bound, for example, at particular corresponding edge portions of the sheets (typically the top or left sides thereof). Wire or comb binders are then attached to the stacked pages, for example, using one or more dedicated machines, or human operators thereby to bind the pages together via the comb or wire binders.

In particular, for certain types of comb or wire binders, binding members thereof are introduced into aligned apertures of the sheets to be bound and are operated such that the binding members bind the pages together. For some comb binders, the binding members are typically connected to a spine and are resiliently biased to curl towards the spine to bind the sheets together to the spine, in use.

In other comb binders, malleable or deformable binding members connected to a spine are deformed to move the binding members to bind the sheets together to the spine, in use.

In some example embodiments, the binders comprise a plurality of binding members in the form of malleable or deformable C-shaped rings which may be receivable in the aligned apertures of the sheets. Each C-shaped ring is then deformed to bring ends together to form a loop thereby binding the sheets together, in use.

In some cases, the wire binder comprises a single corkscrew-like binder which may be threaded through the aligned apertures to bind the sheets together, in use. In this case, individual loops of the corkscrew-like binder are effectively binding members which bind the sheets together, in use.

In summary, the binding members in the apertures typically bind the sheets together such that each binding member is flanked by other binding members. Once attached to the sheets, it is very difficult to remove the binders therefrom. In addition, once bound, it is very difficult for sheets to be removed or introduced into the bound file.

It is therefore an object of the present invention to address some of the difficulties associated with bound files of the type having a plurality of binding members which bind sheets of the file together.

### SUMMARY OF THE INVENTION

According to a first aspect of the invention, there is provided a file note device for use with a file or stack of sheets bound together by way of one or more binding members disposed through substantially aligned apertures in the sheets, the file note device comprising a planar body including:
a note zone; and
an engagement zone located adjacent an edge portion of the planar body, the engagement zone comprising at least one pair of spaced apart teeth defining a binding member recess therebetween, wherein at least one tooth defines a retaining formation for removably retaining the binding member in the binding member recess, in use.

The engagement zone may comprise a plurality of aligned teeth provided in a row between end teeth.

The sheets may be planar sheets of paper, plastic, a composite, or the like.

The teeth shoulder may typically each other and may be spaced by the binding member recesses.

It will be noted that each tooth may define one or two retaining formations which project or protrude transversely to a longitudinal axis of the tooth, toward adjacent teeth. Each tooth may be symmetrical and may comprise a retaining formation on either side thereof, extending toward adjacent teeth.

The retaining formations may comprise flanges which project or protrude into the binding member recesses.

The retaining formations may optionally frictionally engage and retain the binding members in the binding member recesses.

It will be noted that each tooth may comprise guiding formations for guiding the binding members to the binding member recess. The guiding formations comprise chamfered edges adjacent the retaining formations for facilitating guiding or locating the binding members between the pair of teeth.

Each tooth may comprise a body having a stalk connected to a substantially mushroom-shaped head with chamfered lateral edges to guide the binding member into the binding member recess, in use. It will be understood that retaining formations may comprise lateral end portions of the mushroom-shaped head.

The teeth may be resiliently deformable or displaceable relative to each other, to receive the binding members in the binding member recess.

The engagement zone may be constructed of a more durable material than the note zone.

The engagement zone may be laminated and/or constructed of a plastic material and the note zone may be constructed from a material which may be written on.

The note zone may be constructed from one or a combination of paper, plastic, rubber or composite material.

The note zone may be provided in a plurality of different shapes

In one example embodiment of the invention, the file note device may comprise a processor, power source, and wherein the note zone comprises a planar display panel for displaying and optionally receiving data.

The processor may comprise a set of computer executable instructions to direct operation of the display panel.

The file note device may comprise a user interface module to receive inputs from a user for display on the display panel.

The file note device may be substantially the same size as the sheet/s.

In other example embodiments, the note zone is substantially the same size as the sheet/s. However, it will be appreciated that the size and or shape of the engagement zone may be different from the size and or shape of the note zone.

According to a second aspect of the invention, there is provided a bound file comprising a plurality of sheets bound together by way of at least a plurality of binding members disposed in substantially aligned apertures in the sheets, the bound file comprising one or more file note file note devices, wherein each file note device comprises a planar body including:
a note zone; and
an engagement zone located adjacent an edge portion of the planar body, the engagement zone comprising at least one pair of spaced apart teeth defining a binding member recess therebetween, wherein at least one tooth defines a retaining formation for removably retaining the binding member in the binding member recess, in use.

It will be understood that the file note device may be similar to the device as hereinbefore described.

According to a third aspect of the invention there is provided a method of providing a note on a file or stack of sheets bound together by way of one or more binding members disposed through substantially aligned apertures in the sheets, the method comprising:
providing a file note device comprising a planar body including a note zone; and an engagement zone located adjacent an edge portion of the planar body, the engagement zone comprising at least one pair of spaced apart teeth defining a binding member recess therebetween, wherein at least one tooth defines a retaining formation for removably retaining the binding member in the binding member recess, in use;
receiving at least one binding member in the binding member recess between a pair of teeth of the file note device in response to urging of the binding member into engagement with the file note device; and
retaining, removably, the at least one binding member substantially within the binding member recess.

The method may comprise deforming at least one of the pair of teeth to receive the at least one binding member in the binding member recess in response to urging of the binding member into abutment with the teeth.

The method may also comprise providing guide means between the pair of teeth for guiding or locating the binding member between the pair of teeth.

It will be appreciated that the file note device may be similar to the file note device as hereinbefore described.

### BRIEF DESCRIPTION OF THE DRAWINGS

FIG. 1 shows a top view of a bound file comprising a plurality of sheets and a file note device in accordance with an example embodiment, illustrating the teeth thereof in greater detail;

FIG. 2 shows a top view of a bound file of FIG. 1 with the file note device attached to the bound file, illustrating the teeth attached to binding members of the bound file in greater detail;

FIG. 3 shows a top view of a bound file of FIG. 1 with a plurality of file note devices attached thereto, on different pages thereof;

FIG. 4 shows a top view of another file note device in accordance with an example embodiment; and

FIG. 5 shows a top view of another file note device in accordance with an example embodiment.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

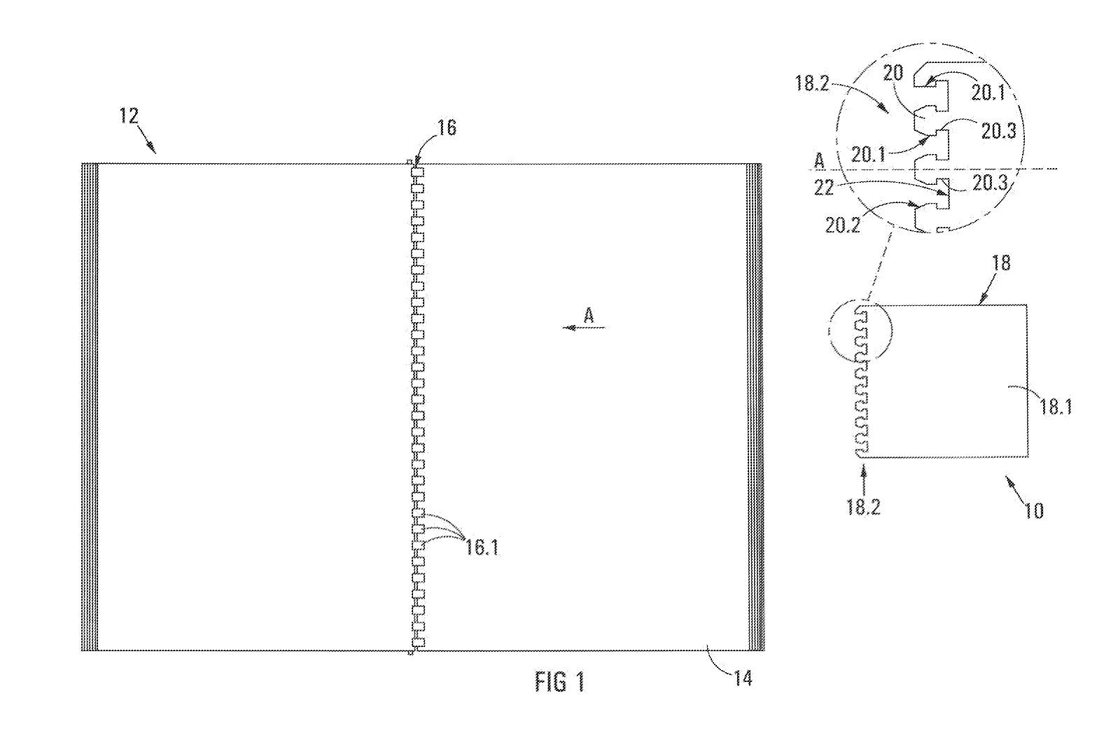

Referring to FIGS. 1 to 3 of the drawings, a file note device in accordance with an example embodiment is generally indicated by reference numeral 10.

The device 10 is typically for use with a file 12 or pad of sheets 14 bound together by way of at least a plurality of binding members 16.1 of a binder 16, for example, a comb binder disposed in substantially aligned apertures in the sheets 14. The comb binder 16 may typically be a conventional binder of the type having a spine to which the plurality of binding members 16.1 is attached and resiliently curved toward the same thereby to bind the sheets 14 together.

It will be understood that the invention as described herein is not limited to use with binders 16. It follows that the binder may be selected from any number of binders which bind sheets together by way of binding members which are disposed in aligned apertures provided in the sheets 14 such that adjacent binding members shoulder each other once attached to the sheets 14. To this end, the binding members may be separate, individual members such as the C-shaped rings previously mentioned. Instead, the binding members may be portions of a corkscrew-like binder such that portions of the corkscrew-like binder are provided as binding members in the aligned apertures of the sheets 14. In any event, the binding members typically shoulder each other in attachment to the sheets and bind the sheets 14 together, in use.

The sheets 12 may be planar sheets constructed of any one or more of plastic, paper, cardboard, metal, and the like.

As can be seen more clearly in FIG. 1, the file note device 10 typically comprises a planar body 18 having a note zone 18.1 and an engagement zone 18.2 located at an edge portion of the body 18. The engagement zone 18.2 advantageously comprises a plurality of spaced apart teeth 20 in a row defining binding member recesses 22 (FIG. 1) between adjacent teeth 20 for receiving the binding members 16.1. In the illustrated example, recesses 22 are defined by straight edges to provide a roughly part-square or part-rectangular recess. However, in certain example embodiments, the recesses may be tear-drop shaped, part-circular, etc.

It will be appreciated that the teeth 20 may shoulder or flank each other and may be spaced by the binding member recesses 22. In addition, each tooth 20 conveniently defines or comprises one or two retaining formations 20.1 which project toward adjacent teeth 20. In addition, it will be noted that the retaining formations 20.1 comprise flanges which project on each side of the teeth 20 into the adjacent binding member recesses 22. It will be understood that end teeth 20 may typically comprise only one retaining formation 20.1.

Differently defined, the retaining formations 20.1 may be protrusions which extend transverse to a longitudinal axis A of each tooth 20. In addition, save for the end teeth 20, each tooth 20 may be symmetrical about the axis A.

Each tooth 20 may optionally define guiding formations 20.2 for guiding the binding members 16.1 to the binding member recesses 22. The guiding formations 20.2 may typically comprise chamfered edges adjacent the retaining formations 20.1. In some example embodiments, not illustrated, the guiding formations may comprise a guiding channel to assist in guiding the binding members to the binding member recesses.

The teeth 20 may be T-shaped. In one example embodiment, each tooth 20, bar the end teeth 20, may be roughly mushroom-shaped have a stalk 20.3 extending from between adjacent recesses 22 and a bulbous head with chamfered top flank edges to automatically channel the binding members 16.1 into the binding member recesses 22 when urged against the members 16.1. To this end, the teeth 20 may be resiliently deformable or displaceable relative to each other, to receive the binding members in the binding member recess.

The note zone 18.1 may be may be constructed from a material which may be written on, for example, paper, plastic, transparent film, etc. The note zone 18.1 may be constructed from one or more materials. It will be appreciated that the opposed planar surfaces of the note zone 18.1 may be written on. In other words, the note zone 18.1 may provide opposed writing surfaces. The note zone 18.1 may be erasable and reusable. In certain example embodiments, the note zone 18.1 may comprise an electronic page configured to be written on by a corresponding electronic pen or stylus.

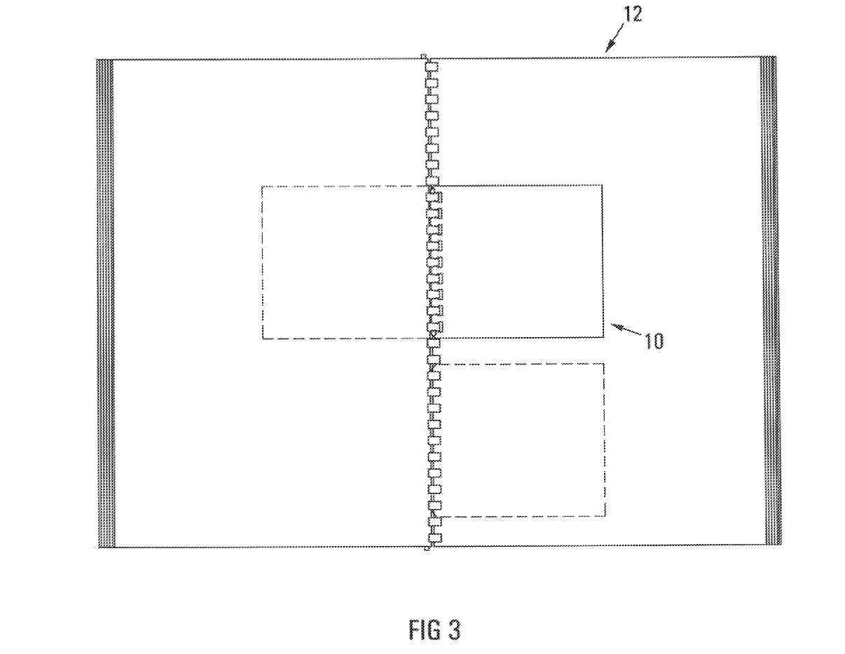

The device 10 may be smaller than sheets 14 of the bound file 12. However, the device 10 and or the note zone 18.1 may be substantially the same size as the sheets 14. In one example embodiment, the note zone 18.1 is substantially the same size as the sheet/s 14 but the engagement zone 18.2 is smaller in size than the note zone 18.1 (not illustrated). A note zone 18.1 of any size or shape may have an engagement zone that is larger or smaller in size than the note zone (not illustrated). In other words, an engagement zone may be of a different size and or shape to the size and or shape of the note zone (not illustrated). Referring to FIG. 3, the devices 10 may be provided between sheets 14 of the file 12.

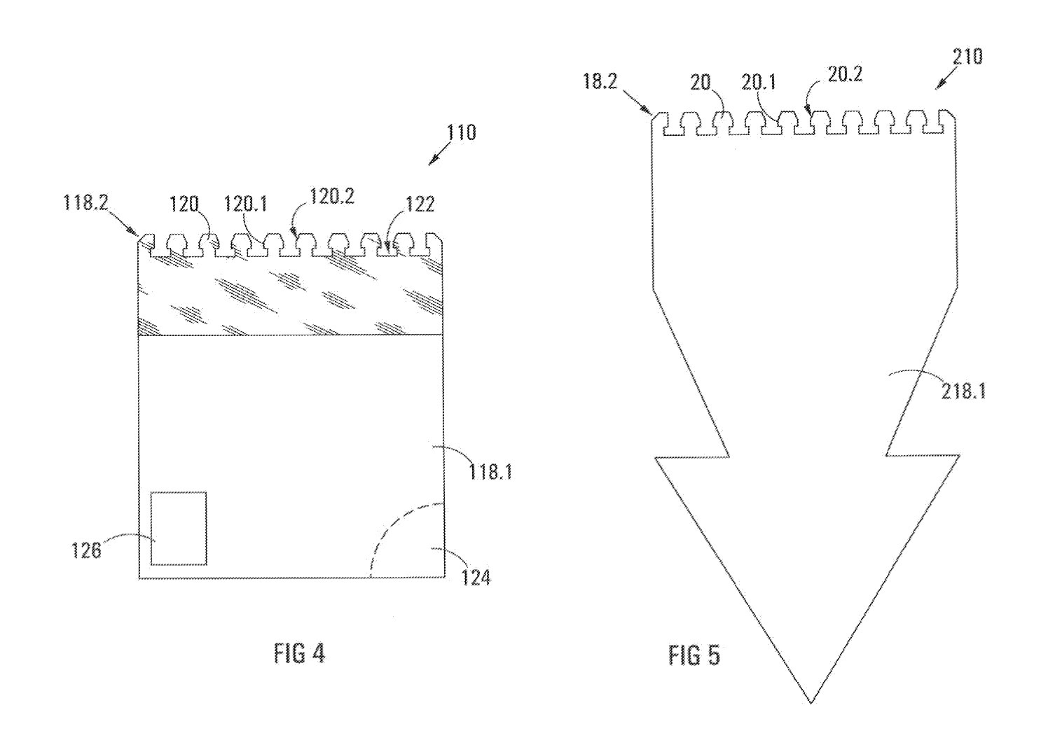

Referring to FIGS. 4 and 5 of the drawings where further example embodiments of the file note device in accordance with the invention are generally indicated by reference numerals 110 and 210 respectively. The devices 110, 210 are similar to the device 10 as hereinbefore described and similar components may be referred to by like reference numerals.

While the device 10 may be constructed of the same material, the engagement zone 118.2 of the device 110 may be constructed of a more durable material than the note zone 118.1. To this end, the engagement zone 118.2 may be laminated and/or constructed of a plastic/rubber or composite material. In this way, the teeth 120 are resiliently deformable to be attached to the binder members 16.1 and removed therefrom without breaking or substantially damaging the teeth 120. It will be noted that adjacent teeth 120 may displace away from each other to receive the binding members 16.1 in the recesses.

The note zone 118.1 may comprise cut away portions 124 or patterning and/or indicia 126 such as branding or logos provided thereon (not illustrated). The cut away portions 124 may be provided with perforations to enable selective tearing of the portions 124. In some cases, perforations may be provided along the length of the note zone 118.1, parallel to the row of binding members 16.1. For example, the perforations may be provided at an intersection of the engagement zone 118.2 and the note zone 118.1 such that the note zone 118.1 may be conveniently torn from the file note device 110, if desired.

For the file note device 210, the note zone 218.1 may be of different geometric or bespoke shapes.

In some example embodiments, some or all of the sheets may be devices as hereinbefore described.

In use, referring to FIGS. 1 to 5, it will be appreciated that users desiring to include ad hoc notes in the form of written data on planar sheets to a bound file 12 often find difficulty in doing so as these notes will have to be affixed to bound sheets 14 of the file 12, by adhesion, staples, or the like. This is especially difficult as these notes often become dislodged from the file 12 and may be easily misplaced.

In most cases, to include the notes to the bound file 12, other than by attaching them to existing pages, the the comb binder 16 is operated (via specialised machinery, for example) to release the same from the sheets 14. Aligned apertures are then provided in the ad hoc note substantially at an edge portion thereof similar to the bound sheets 14. The note is then placed at a desired location amongst the sheets 14 and apertures are aligned for the introduction of the binding members 16.1 therein (also via the specialised machinery). The binder 16 is then operated in a conventional fashion to bind the sheets 14 together with the note at the desired location therebetween.

Though ensuring attachment to the bound file 12, the above described procedure is both time consuming and tedious, especially for a single note.

To this end, the users may write down data on the note zone 18.1, 118.1, 218.1 of the device 10, 110, 210 and conveniently removably attach the same to the bound file by forcing the engagement zone 18.2, 118.2 into contact with the binding members 16.1 which shoulder each other. This may be done at a desired location between the sheets 14 of the file 16. In any event, when urged in a direction transverse to a longitudinal axis of the spine of the binder 16, toward the binding members 16.1, (in the direction of arrow A, FIG. 1). Adjacent guiding formations 20.2, 120.2 (next to each other) engage the binding members 16.1 and channel the same to the recess 22, 122. To this end, it will be appreciated that adjacent teeth 20, 120 may displace slightly to enable the binding members 16.1 to travel to the recess 22, 122.

Once received in the recess 22, 122, the binding members 16.1 may be retained therein by way of adjacent retaining formations 20.1, 120.1 which project into the recesses 22, 122 substantially to retain the binding members 16.1 in the recesses 22, 122.

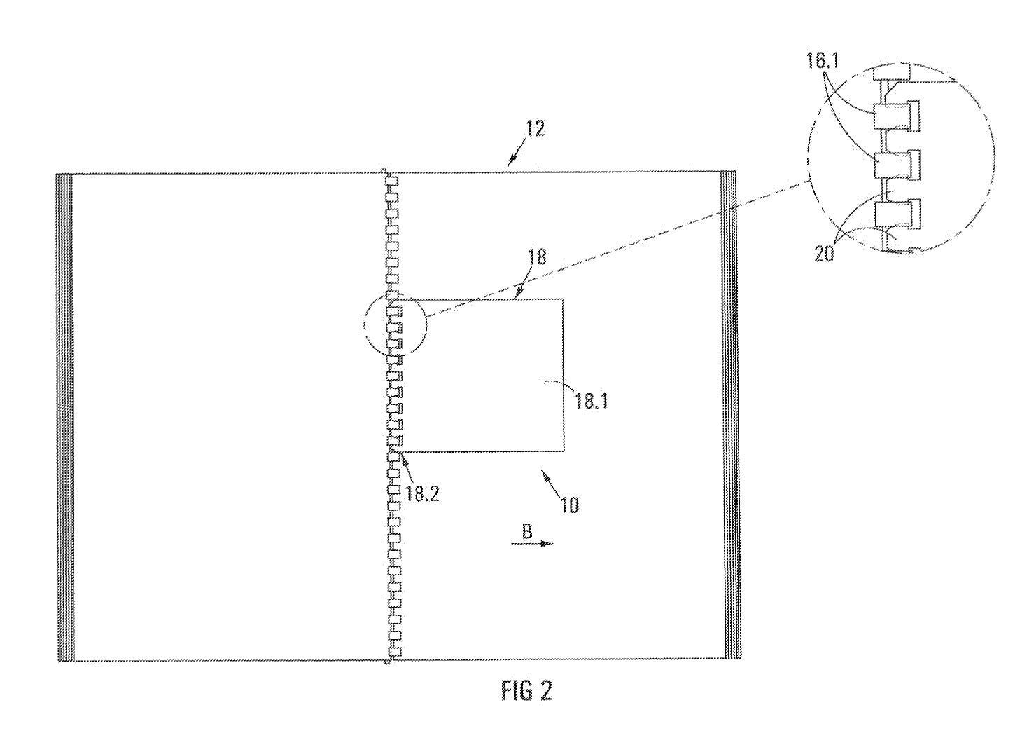

Since adjacent teeth are not attached to each other, removing the file note device 10, 110, 210, from the file 16 typically entails operating the same to dislodge the binding members 16.1 from the recesses 22, 122, either by force (by pulling the device 10, 110, 210 in a direction of arrow B, FIG. 2) or by manual manipulation.

Resilience and/or the configuration of the teeth 20, 120 typically ensure that the engaging zone 18.2, 118.2 is not damaged by attachment and detachment of the device 10, 210, 110 from the file 12.

It will be noted that in some example embodiments (not illustrated), the file note device comprises a processor, power source, and the note zone comprises a planar display panel for displaying and optionally receiving data. In this example embodiment, the processor comprises a set of computer executable instructions to direct operation of the display panel. It will be understood that the file note device in accordance with this example embodiment comprises a user interface module to receive inputs from a user for display on the display panel. The user interface module may comprise a touch screen display responsive to human touch or a stylus to receive inputs and display outputs to a user in a conventional manner as a tablet computing device.

The present invention provides a convenient way in which a note may be attached to a bound file retrospectively without the need to remove the binder. In addition, it also conveniently provides a manner in which unwanted notes may be removed from the file easily.

1. A file note device for use with a file or stack of sheets bound together by way of one or more binding members disposed through substantially aligned apertures in the sheets, the file note device comprising a planar body including:
a note zone; and
an engagement zone located adjacent an edge portion of the planar body, the engagement zone comprising at least one pair of spaced apart teeth defining a binding member recess therebetween, wherein at least one tooth defines a retaining formation for removably retaining the binding member in the binding member recess, in use.

2. A file note device as claimed in claim 1, wherein the engagement zone comprises a plurality of aligned teeth provided in a row between end teeth.

3. A file note device as claimed in claim 2, wherein the teeth shoulder each other and are spaced by the binding member recesses.

4. A file note device as claimed in claim 2, wherein the each tooth defines one or two retaining formations which project or protrude transversely to a longitudinal axis of the tooth, toward adjacent teeth.

5. A file note device as claimed in claim 2, wherein each tooth is symmetrical and comprises a retaining formation on either side thereof, extending toward adjacent teeth.

6. A file note device as claimed in claim 2, wherein the retaining formations comprise flanges which project or protrude into the binding member recesses.

7. A file note device as claimed in claim 2 wherein the retaining formations frictionally engage and retain the binding members in the binding member recesses.

8. A file note device as claimed in claim 1, wherein each tooth comprises guiding formations for guiding or locating the binding member between the pair of teeth.

9. A file note device as claimed in claim 8, wherein the guiding formations comprise chamfered edges adjacent the retaining formations for facilitating guiding or locating the binding members between the pair of teeth.

10. A file note device as claimed in claim 1, wherein each tooth comprises a body having a stalk connected to a substantially mushroom-shaped head with chamfered lateral edges to guide the binding member into the binding member recess, in use.

11. A file note device as claimed in claim 10, wherein the retaining formations comprise lateral end portions of the mushroom-shaped head.

12. A file note device as claimed in claim 2, wherein the teeth are resiliently deformable or displaceable relative to each other, to receive the binding members in the binding member recess, in use.

13. A file note device as claimed in claim 1, wherein the engagement zone is constructed of a more durable material than the note zone.

14. A file note device as claimed in claim 1, wherein the engagement zone is laminated and/or constructed of a plastic material and the note zone is constructed from a material which may be written on.

15. A file note device as claimed in claim 1, wherein the note zone is constructed from one or a combination of paper, plastic, rubber or composite material.

16. A file note device as claimed in claim 1, wherein the note zone is provided in a plurality of different shapes.

17. A file note device as claimed in claim 1, the file note device comprising a processor, power source, and wherein the note zone comprises a planar display panel for displaying and optionally receiving data.

18. A file note device as claimed in claim 17, wherein the processor comprises a set of computer executable instructions to direct operation of the display panel.

19. A file note device as claimed in claim 17, wherein the file note device comprises a user interface module to receive inputs from a user for display on the display panel.

20. A file note device as claimed in claim 1, wherein the note zone comprises one or more of cut away portions, indicia and patterning thereon.

21. A file note device as claimed in claim 20, wherein the cut away portions, patterning and/or indicia comprise branding or logos.

22. A file note device as claimed in claim 16, wherein the shape of the note zone comprises a logo.

23. A file note device as claimed in claim 1, wherein the file note device is substantially the same size as the sheet/s.

24. A file note device as claimed in claim 1, wherein the note zone is substantially the same size as the sheet/s.

25. A file note device as claimed in claim 1, wherein the size and or shape of the engagement zone is different from the size and or shape of the note zone.

26. A bound file comprising a plurality of sheets bound together by way of at least a plurality of binding members disposed in substantially aligned apertures in the sheets, the bound file comprising one or more file note devices, wherein each file note device comprises a planar body including:
a note zone; and
an engagement zone located adjacent an edge portion of the planar body, the engagement zone comprising at least one pair of spaced apart teeth defining a binding member recess therebetween, wherein at least one tooth defines a retaining formation for removably retaining the binding member in the binding member recess, in use.

27. A method of providing a note on a file or stack of sheets bound together by way of one or more binding members disposed through substantially aligned apertures in the sheets, the method comprising:
providing a file note device comprising a planar body including a note zone;
and an engagement zone located adjacent an edge portion of the planar body, the engagement zone comprising at least one pair of spaced apart teeth defining a binding member recess therebetween, wherein at least one tooth defines a retaining formation for removably retaining the binding member in the binding member recess, in use;
receiving at least one binding member in the binding member recess between a pair of teeth of the file note device in response to urging of the binding member into engagement with the file note device; and
retaining, removably, the at least one binding member substantially within the binding member recess.

28. A method as claimed in claim 27, wherein the method comprises deforming at least one of the pair of teeth to receive the at least one binding member in the binding member recess in response to urging of the binding member into abutment with the teeth.

29. A method as claimed in claim 27, wherein the method comprises providing guide means between the pair of teeth for guiding or locating the binding member between the pair of teeth.
